(19) United States
(12) Patent Application Publication
(10) Pub. No.: US 2008/0240504 A1
(43) Pub. Date: Oct. 2, 2008

(54) Integrating Object Detectors

(75) Inventor: David Grosvenor, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 12/057,713

(22) Filed: Mar. 28, 2008

(30) Foreign Application Priority Data
Mar. 29, 2007 (GB) 0706067.6

(51) Int. Cl. G06K 9/00

(52) U.S. Cl. 382/103

(57) ABSTRACT

An N-object detector comprises an N-object decision structure incorporating decision sub-structures of N object detectors. Some decision sub-structures have multiple different versions composed of the same classifiers with the classifiers rearranged. Said multiple versions associated with an object detector are arranged in the N-object decision structure so that the order in which the classifiers are evaluated is dependent upon the results of the evaluation of a classifier of another object detector. Each version of the same decision sub-structure produces the same logical behaviour as the other versions. Such an N-object decision structure is generated by generating multiple candidate N-object decision structures and analysing the expected computational cost of these candidates to select one of them.

### RELATED APPLICATIONS

The present application is based on, and claims priority from, United Kingdom Application Number 0706067.6, filed Mar. 29, 2007, the disclosure of which is hereby incorporated by reference herein in its entirety.

### TECHNICAL FIELD

This invention relates to the detection of multiple types of object or features in images. Face detectors are known from the work of Viola and Jones (“Robust real time object detection”; Second International Workshop on Statistical and Computational Theories of Vision—modelling, learning, computing and sampling; Vancouver, Canada Jul. 13, 2001).

Typically, a face detector comprises a complex classifier that is used to determine whether a patch of the image is possibly related to a face. Such a detector usually conducts a brute force search of the image over multiple possible scales, orientations, and positions. In turn, this complex classifier is built from multiple simpler or weak classifiers each testing a patch for the presence of simple features, and these classifiers form a decision structure that coordinates the decision for the patch. In the Viola-Jones approach, the decision structure is a fixed cascade of weak classifiers which is a restricted form of a decision tree. For the detection of the presence of a face, if a single weak classifier rejects a patch then an overall decision is made to reject the patch as a face. An overall decision to accept the patch as a face is only made when every weak classifier has accepted the patch.

The cascade of classifiers is employed in increasing order of complexity, on the assumption that the majority of patches are readily rejected by weak classifiers as not containing a face, and therefore the more complex classifiers that must be run to finally confirm acceptance of a patch as containing a face are run much less frequently. The expected computational cost in operating the cascade is thereby reduced. A learning algorithm such as “AdaBoost” (short for adaptive boosting) can be used to select the features for classifiers and to train the classifier using example images. AdaBoost is a meta-algorithm which can be used in conjunction with other learning algorithms to improve their performance. AdaBoost is adaptive in the sense that subsequent classifiers built are tweaked in favour of those instances misclassified by previous classifiers. The classifiers are each trained to meet target detection and false positive rates, and these rates are increased with successive classifiers in a cascade, thereby generating classifiers of increasing strength and complexity.

In analysing an image, a Viola and Jones object detector will analyse patches throughout the whole image and at multiple image scales and patch orientations. If multiple object detectors are needed to search for different objects, then each object detector analyses the image independently and the associated computational cost therefore rises linearly with the number of detectors. However, most object detectors are rare-event detectors and share a common ability to quickly reject patches that are non-objects using weak classifiers. The invention makes use of this fact by integrating the decision structures of multiple different object detectors into a composite decision structure in which different object evaluations are made dependent on one another. This reduces the expected computational cost associated with evaluating the composite decision structure.

### SUMMARY OF THE PRESENT INVENTION

According to one aspect the present invention there is provided an N-object detector comprising an N-object decision structure incorporating multiple versions of each of two or more decision sub-structures interleaved in the N-object decision structure and derived from N object detectors each comprising a corresponding set of classifiers, some decision sub-structures comprising multiple versions of a decision sub-structure with different arrangements of the classifiers of one object detector, and these multiple versions being arranged in the N-object decision structure so that the one used in operation is dependent upon the decision sub-structure of another object detector, wherein at least one route through the N-object decision structure includes classifiers of two different object detectors and one of the two object detectors occurs both before and after a classifier of the other of the two object detectors and there exists multiple versions of each of two or more of the decision sub-structures of the object detectors, whereby the expected computational cost of the N-object decision structure in detecting the N objects is reduced compared with the expected computational cost of the N object detectors operating independently to detect the N objects.

The N-object detector can make use of both the accept and reject results of the classifiers of an object detector to select different versions of following decision sub-structures of the object detectors, and because the different versions have different arrangements of classifiers with different expected computational cost, the expected computational cost can be reduced. That is, a patch being evaluated can be rejected sooner by selection of an appropriate version of the following decision sub-structure. An object detected in an image can be a feature, such as a feature of a face for example, or a more general feature such as a characteristic which enables the determination of a particular type of object in an image (e.g. man, woman, dog, car etc). The term object or feature is not intended to be limiting.

In one embodiment of the invention, the dependent composition of the decision sub-structures is achieved by evaluating all the classifiers of one decision sub-structure before evaluating any of the classifiers of a later decision sub-structure so that the classifier decisions are available to determine the use of the different versions of a said later decision sub-structure. Preferably, the classifier decisions are obtained by evaluating all the classifiers of each decision sub-structure either completely before or completely after any other of the decision sub-structures. This makes information available to the other decision sub-structures and allows the following decision sub-structure to be re-arranged into different versions of a sub-structure and for these re-arrangements to be dependent on these earlier or prior classifier decisions. In this case, the particular order in which decision sub-structures are evaluated is optimised. This is different from sequential composition of two or more decision structures because some decision sub-structures are re-arranged.

Dependency is only created in one direction when the set of classifiers from each decision sub-structure is evaluated either completely before or completely after another. Better results are possible if the evaluations of two decision sub-structures are interleaved then the dependency can be two-way. By interleaving the decision sub-structures with one another, the whole set of decision sub-structure evaluations becomes inter-dependent or in the extreme, N-way dependent. Thus, according to other embodiments of the invention decision sub-structures are interleaved in the N-object decision sub-structure.

Two decision sub-structures are interleaved in an N-object decision structure if there is at least one route through the N-object decision structure where at least one classifier from one set occurs both before and after a classifier from another set.

A route through a decision structure comprises a sequence of classifiers and results recording the evaluation of a patch by the decision structure. A route through an N-object decision structure is similar but there is a need to record each of the N different decisions when they occur as well as the trace of the classifier evaluations.

However, interleaving on its own does not create dependency between two decision sub-structures because the results from the classifiers of one decision sub-structure can be ignored or the same actions occur whatever the results. For dependency, there has to be some re-arrangement of the classifiers in the decision sub-structures i.e. a choice between different versions of decision sub-structures.

Different versions of the decision sub-structures have different expected computational costs because they cause the component or weak classifiers to be evaluated in a different order. For example, if all classifiers cost the same to evaluate then in a cascade of classifiers it is best to evaluate the classifier that is most likely to be rejected, and so cascades evaluating the classifiers in a different order will not be optimum.

The availability of other classifier results from other decision sub-structures allows the space of possible patches to be partitioned into different sets, and within each such set there might be a different classifier that is most likely to be rejected. This allows different versions of the decision sub-structures to be optimum for the different partitions.

According to another aspect of the present invention there is provided a method for generating an N-object decision structure for an N-object detector comprising: a) providing N object detectors each comprising a set of classifiers, b) generating multiple N-object decision structures each incorporating decision sub-structures derived from the N object detectors, some decision sub-structures comprising multiple versions of a decision sub-structure with different arrangements of the classifiers of an object detector, and these multiple versions being arranged in at least some N-object decision structures so that at least one version of a decision sub-structure of an object detector is dependent upon the decision sub-structure of another object detector, and c) analyzing the expected computational cost of the N-object decision structures in detecting all N objects and selecting for use in the N-object detector an N-object decision structure according to its expected computational cost compared with the expected computational cost of the N object detectors operating independently.

According to another aspect of the present invention there is provided an object detector for determining the presence of a plurality of objects in an image, the detector comprising a plurality of object decision structures incorporating decision sub-structures derived from a plurality of object detectors each comprising a corresponding set of classifiers, wherein a portion of the decision sub-structures comprise multiple versions of a decision sub-structure with different arrangements of the classifiers of one object detector, wherein the multiple versions are arranged in the decision structure such that the one used in operation is dependent upon the decision sub-structure of another object detector.

According to a further aspect of the present invention, there is provided an object detector generated according to the method as claimed in any of claims 22 to 42.

According to another aspect of the present invention there is provided a method for generating a multiple object decision structure for an object detector comprising: a. providing a plurality of object detectors each comprising a set of classifiers; b. generating a plurality of object decision structures each incorporating decision sub-structures derived from the object detectors, wherein a portion of the decision sub-structures comprise multiple versions of a decision sub-structure with different arrangements of the classifiers of an object detector, wherein the versions are arranged in at least some object decision structures so that at least one version of a decision sub-structure of an object detector is dependent upon the decision sub-structure of another object detector; and c. analyzing the expected computational cost of the object decision structures in detecting all desired objects and selecting for use in the object detector an object decision structure according to its expected computational cost compared with the expected computational cost of the object detectors operating independently.

Selection of an N-object decision structure is facilitated using a restriction operation to analyse the multiple candidate structures. The restriction operation serves to restrict an N-object decision structure to the classifiers of a particular decision sub-structure. In general, this restriction operation yields a set of decision sub-structures obtained by hiding the classifiers from the other decision sub-structures and introducing a set of alternative decision structures for each of the choices introduced by the hidden classifiers. If the restriction operator yields a singleton set corresponding to a particular object detector then there are no rearrangements to exploit any of the partitions created by evaluating classifiers associated with other object detectors. If the restriction operator yields a set with two or more decision sub-structures then this decision sub-structure must be dependent on some of the other decision sub-structures.

Selection of an N-object decision structure from multiple candidates therefore involves analysis of the candidates using derived statistical information of the interdependencies between the results of classifiers in different sub-structures. A cost function is then used to predict the expected computational cost of the different N-object decision structures to select one with the lowest expected computational cost.

This enables a different approach to object detection or classification. It allows the use of more specific object detectors, such as detectors for a child, a man, a woman, spectacles wearer, etc. that share the need to reject many of the same non-objects. This allows the Viola and Jones training to be based on classes of objects with less variability within the class, enabling better individual detectors to be obtained and then using the invention to reduce the computational burden of integrating these more specific object detectors.

A face detector according to an embodiment incorporates multiple object detectors, each corresponding to a separate facial feature such as an eye, a mouth, a nose or full face, and the decision sub-structure for these are interleaved in a decision tree.

The invention is also applicable to multi-pose and multi-view object detectors which are effectively hybrid detectors. The multiple poses and views involved would each be related to different object detectors, which would then have predictable dependencies between their classifiers so that a suitable overall decision structure can be constructed.

The invention can be implemented by the object detectors each analysing the same patch over different scales and orientations over the image field, but respective ones of the object detectors can analyse different patches instead, providing there are interdependencies between these patches which can be exploited by interleaving the detector decision sub-structure to reduce the expected computational cost. Patches which are close in terms of scale, translation and orientation, are likely to display interdependencies in relation to the same object. Thus multiple object detectors each analysing one of multiple different close patches could operate effectively as a detector of a larger patch. For example, each small patch might relate to a facial feature detector such as ear, nose, mouth or eye, detector which are expected to be related to a larger patch in the form of a face. Furthermore, each of the multiple object detectors might use a different size patch, and sometimes, as in the case of the multi-pose and multi-view object detectors referred to above, the patches may comprise a set of possible translations of one patch.

Multiview object detectors are usually implemented as a set of single-view detectors (profile, full frontal, and versions of both for different in-plane rotations) with the system property that only one of these objects can occur. Although it can be argued that this exclusivity property could apply to all object detectors (dog, cat, mouse, person, etc.), other detectors such as a child detector, a man detector, a woman detector, a bearded person detector, a person wearing glasses detector, a person wearing a hat detector are examples of detectors that detect attributes of an object and so it is reasonable that several of these detectors return a positive result.

In general some of the object detectors being integrated will have an exclusivity property with some but not all of the other detectors. If this property is desired or used then as soon as one of the detectors in an exclusive group reaches a positive decision then none of the other detectors can return a positive decision and so further evaluation of that detector's decision tree could be stopped.

Although usually there is some prioritised decision, and decisions will not always be forced when any one of the grouped object detector reaches a positive decision, essentially another logical structure is employed to integrate the result and force a detector decision between two mutually exclusive object decisions. From a computational cost perspective this extra integration decision structure does not save or add significant cost (because broadly the cost is determined by the cost of rejecting non-objects).

The decision sub-structures from different versions can be clipped and would exhibit a weaker property than having the same logical behaviour. Essentially such clipped decision sub-structures have the property that they are strictly less discriminating than the full decision sub-structure. i.e. they reject less patches than another version of the decision structure that is not clipped. Unclipped decision sub-structures will all exhibit the same logical behaviour, i.e. they accept and reject the same patches. The clipped decision sub-structures will not have reached a positive decision (not accepted the proposition posed by the object detector) but will reject a subset of the patches rejected by an unclipped decision sub-structure.

In this application the term “decision sub-structure” is meant to include any arbitrary decision structure: a cascade of classifiers; a binary decision tree, a decision tree with more than two children, an N-object decision structure, or an N-object decision tree, or a decision structure using binning. All these examples are deterministic in that given a particular image patch the sequence of image patch tests and classification tests is defined. However the invention is not limited in application to deterministic decision structures. The invention can apply with non-deterministic decision structures where a random choice (or a choice based upon some hidden control) is made between a set of possible decision structures.

The restriction operator can be viewed as returning a (possibly) non-deterministic decision structure rather than returning a set of decision structures. The non-determinism is introduced because the choices introduced are due to the hidden tests performed by decision sub-structures.

Furthermore the N-object decision structure can be a non-deterministic decision structure. Abstractly the decision sub-structure determines:
1. the order in which image feature tests (i.e. classifiers) are applied to an image patch at run-time;
2. the final run-time classification of an image patch;
3. the re-arrangements (i.e. versioning) that can be performed on a particular decision sub-structure whilst achieving satisfactory logical behaviour.

In order to further improve performance (reduced expected computational cost for example) for a single detector, “binning” can be used. Binning has the effect of partitioning the space of patches, and improved performance is obtained by optimising the order of later classifiers in the decision structure, but can also be used to get improved logical behaviour.

A decision structure using binning passes on to later classifiers information relating to how well a patch performs on a classifier. Instead of a classifier just returning two values (accepting or rejecting a patch as an object) the classifier produces a real or binned value in the range 0 to 1 (say) indicative of how well a test associated with the classifier performs. Usually several such real-valued classifier decisions are combined or weighted together to form another more complex classifier. Usually binning is restricted to a small number of values or bins. So binning gives rise to a decision tree with a child decision tree for every discrete value or bin.

The possible versions of a decision structure permitted depends upon the underlying structure.

When the structure comprises a cascade of classifiers then arbitrary re-ordering of the sequence of the classifiers in the cascade can be done whilst preserving the logical behaviour of the cascade.

When the structure comprises a decision tree then a set of rules is used for transforming from one decision tree into another decision tree with the same logical behaviour. The set of transformation rules can be used to define an equivalent class of decision trees. For example, if the same classifier is duplicated in both the sub-trees after a particular classifier then the two classifiers can be exchanged provided some of the sub-trees are also exchanged. Classifiers can be exchanged if a pre-condition concerning the decision tree is fulfilled, such as insisting that the following action is independent of the result. Other rules can insist that if one decision tree is equivalent to another, then one instance can be substituted for the other in whatever context it is used.

Binning requires a distinction to be made between the actual image patch test and the classification test performed at each stage. In Viola-Jones the cascades of classifiers and image tests were hardly distinguished because the classification test was a simple threshold of the result returned by the image patch test. However in binning or chaining the classification test is a function (usually a weighted sum) of all the image patch tests evaluated so far. Thus the classification test at a given stage is not identified with one image patch test.

Binning can be viewed as a decision-tree with more than two child sub-trees. Thus it has a similar set of transformation rules governing the re-arrangements that can be applied whilst preserving the logical behaviour of the decision structure. However, these pre-conditions severely conflict with how binning is performed and restrict the transformations that can be applied. The preconditions generally assert independency properties. Whilst in the extreme, such binning (or chaining) makes every stage of a cascade dependent on all previous stages, the classifier test at each stage is different from the feature comparison/test evaluated on an image patch. For example, the classifier test at each stage can be a weighted combination of the previous feature comparisons. This makes it important to allow re-arrangements of the decision structure that do not preserve the logical behaviour. These permitted re-arrangements can be defined either during the training phase for a particular object detector, or systematically by using expected values for unknown values or simply the corresponding test with a different set of predefined results (providing that the logical behaviour is acceptable). Thus the permitted re-arrangements are not just determined by the underlying representation but are determined by the particular decision structure. Different possible re-arrangements are exploited to improve performance. The logical place for these re-arrangements to be defined is by the decision structure itself. Furthermore there is no need for these re-arrangements to all have the same logical behaviour. The decision sub-structure should define the permitted re-arrangements or allow some minimum logical behaviour to be characterised that could be used to determine a set of permitted re-arrangements.

The main requirement of binning or chaining in connection with the invention is to restrict the possible versions of the decision sub-structures, and the need to allow a controlled set of versions with slightly different logical behaviour. These requirements are covered in the notion of a decision sub-structure.

### DESCRIPTION OF THE DRAWINGS

The invention will now be described, by way of example only, with reference to the accompanying drawings in which:

FIGS. 1 to 5 are diagrammatic representations of various forms of 2-object decision trees;

FIG. 6 is a diagrammatic representations of an N-object decision structure of an N-object detector according to an embodiment of the present invention;

FIGS. 7 to 11 illustrate transformation rules for equivalent decision trees;

FIGS. 12 to 17 illustrate the application of the transformation rules of FIGS. 7 to 11 to the decision tree of FIG. 1 to generate the decision trees of FIGS. 1 and 5; and

FIGS. 18 and 19 illustrate the process of aggregation.

### MODE OF CARRYING OUT THE INVENTION

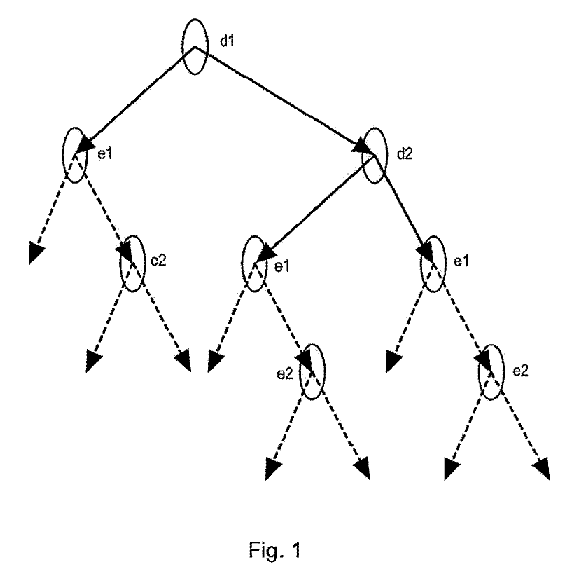

The 2-object decision trees of FIGS. 1 to 5 are composed of object detectors D and E each comprising a cascade of classifiers d1, d2 and e1, e2. The trees make use of “accept” decisions (with arrows pointing left) and “reject” decisions (with arrows pointing right).

Only the classifiers d1, d2, e1, e2 of the two input cascades are used to form the 2-object decision trees. All of the 2-object decision tree will have the same (or acceptably similar) logical behaviour for evaluating each of the input cascades. i.e they each reach two decisions as to whether a patch is a particular object D or E.

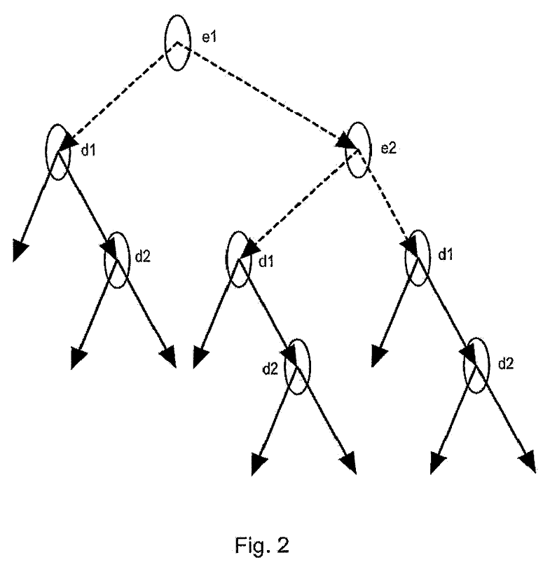

FIGS. 1 and 2 show 2-object decision trees comprising a sequential arrangement of the two cascades, in which one cascade is evaluated to reach a final decision before the other is evaluated. FIG. 1 shows cascade D being evaluated before evaluating any of the classifiers from cascade E. There are three possible decisions from evaluating cascade D:
1. If classifier d1 reaches a reject decision then cascade E is evaluated.
2. If classifier d1 is accepted but d2 is rejected then cascade E is evaluated.
3. If both classifiers d1 and d2 are accepted then cascade E is evaluated.

Whatever the possible decision from evaluating cascade D, the same cascade E is evaluated. In this 2-object decision tree, the evaluations of the two decision sub-structures are independent of each other.

An alternative explanation is to imagine the 2-object decision tree in FIG. 1 restricted to classifiers from one of the two cascades (or hiding the classifiers from the other). In this case, restriction to the classifiers from cascade D requires simply to ignore nodes containing a classifier from cascade E. Restricting the decision tree to classifiers from cascade E requires the root node to be ignored and this potentially gives two decision sub-trees from which to build a decision structure restricted to cascade E. Each node of the decision tree that is ignored will introduced two sub-trees that can be used to compose a cascade from the classifiers of cascade E. In this case, every cascade derived by restriction to the classifiers from cascade E will be the same (the original cascade E).

FIG. 2 shows a 2-object decision tree similar to that of FIG. 1 in which the sequential order of the two cascades D and E are interchanged so that cascade E is evaluated before cascade D, but the analysis of its operation is the same as that of FIG. 1. In particular, because the order of operation of the classifiers d1, d2 and e1, e2 remain unchanged, operation of the object detector E is independent of the object detector D; all of the classifiers of cascade E are evaluated to reach a decision about detecting object E, before evaluating cascade D.

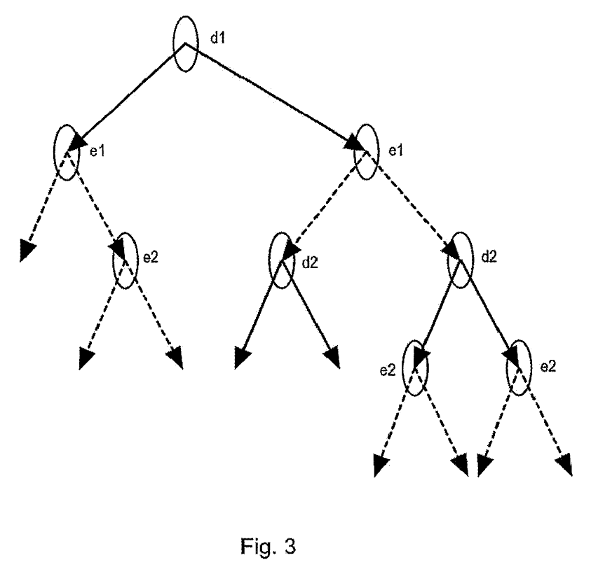

FIG. 3 shows a 2-object decision tree comprising the two cascades D and E, but with the cascades interleaved. That is, classifier d1 is evaluated first but is followed by classifier e1. If the result of classifier d1 is to accept a patch, then classifier e1 is evaluated before classifier d2 is evaluated, followed by classifier e2. The classifiers are therefore always evaluated in the order d1, d2, and e1, e2. Therefore, although the evaluation of the two cascades are interleaved the evaluations of the two cascades are still independent of each other. Whatever route through the decision tree is taken, the classifiers of either cascade are always evaluated in the same order.

The order of the classifiers in the cascade for each object detector can be optimised to give reduced expected computational for each detector evaluated independently of other detectors. Generally this is not done formally, but the classifiers are arranged in increasing order of complexity and each classifier is selected to optimise target detection and false positive rates. This arrangement of the cascade has been found to be computationally efficient. Most patches are rejected by the initial classifiers. The initial classifiers are very simple and reject around 50% of the patches whilst having low false negative rates. The later classifiers are more complex, but have less effect on the expected computational cost. There are known methods for formally optimising the order of classifiers in a cascade to reduce expected computational cost (see for example “Optimising cascade classifiers”, Brendan McCane, Kevin Novins, Michael Albert, Journal Machine Learning Research 2005)

If the classifiers within a single cascade are re-ordered, this will not change their logical behaviour, but it will change the expected computational cost. The expected cost is affected by both the cost of each classifier and the probability of such a classifier being evaluated. The probability of a classifier being evaluated in turn is determined by the particular decision structure (cascade) and the conditional probability of classifiers being accepted given the results from the previous classifiers in the cascade.

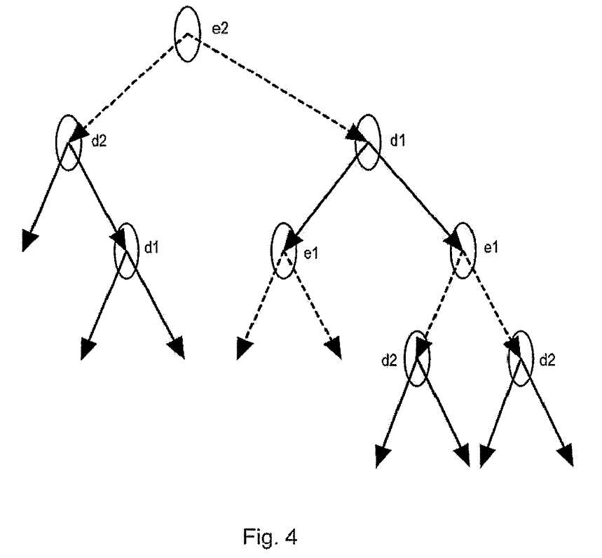

FIG. 4 illustrates another example of an N-object decision tree that incorporates the two object detectors D and E, but in this case, the result of the classifier e2 of the detector E determines the order in which the classifiers d1 or d2 of the detector D are evaluated next. The classifier d2 is the first classifier of cascade D to be evaluated if the classifier e2 reaches a reject decision for a patch, otherwise d1 is evaluated first. Therefore, evaluation of cascade D is dependent upon evaluation of cascade E. This is confirmed if the 2-object decision tree is restricted to classifiers from cascade D, then there are two possible cascades d2, d1 and d1, d2. However, if we restrict the 2-object decision tree of FIG. 4 to classifiers from cascade E, then there is only one cascade e2,e1 and so the evaluation of cascade E is independent of the other cascade D. The change in order of the classifier d1, d2 produces a different expected computational cost between them, with one being reduced, and being selected dependent upon evaluation of classifier e₂.

Therefore, the expected computational cost of the decision tree of FIG. 4 will in general be different to that of one independently evaluating the two cascades. The invention seeks to make use of such decision trees where the expected cost is reduced. In the case of FIG. 4 any cost reduction should come from evaluating the different arrangements or versions of cascade D. As there is only one version or arrangement of cascade E, there is no improvement in the expected cost of evaluating this cascade with the other cascade. The evaluation of cascade E provides information that enables the other cascade to run faster. In fact, it might even be the case that the cascade arrangement e2, e1 is slower than the arrangement e1, e2, but the overall expected computational cost of evaluating the decisions of both detectors might still be reduced.

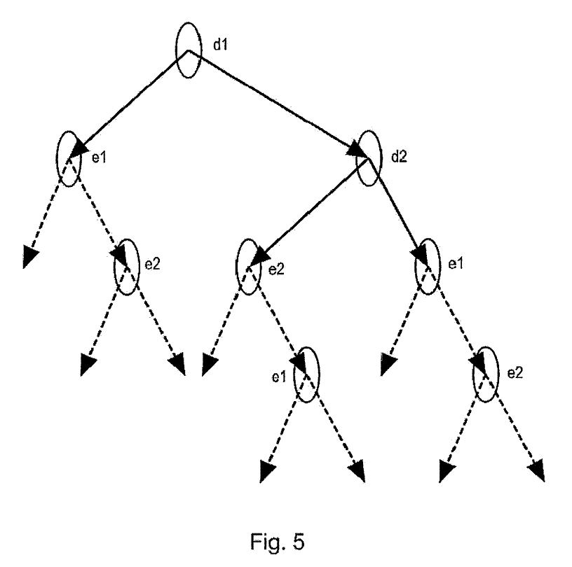

As another example, FIG. 5 illustrates a 2-object decision tree in which there is just one version of cascade D with the classifiers in the order d1, d2; and two versions of cascade E with the classifiers in the order e1, e2 and e2, e1 respectively. This 2-object decision tree has the same logical behaviour as that of FIG. 1 but has possibly different expected computational costs (depending on the cost of the image feature test and probabilities). This 2-object decision tree of FIG. 5 would no longer evaluate the decision sub-structures independently because the cascade E would be evaluated in the order e1, e2 on some occasions and in the order e2, e1 on other occasions depending upon some of the results of the classifiers in cascade D.

FIGS. 4 and 5 therefore illustrate how, in an N-object decision tree including classifiers from multiple object detectors, it is possible to change the evaluation order of the classifiers of one object detector dependent upon results of a classifier from another object detector. The re-ordering of classifiers to produce different versions of a cascade is a significant feature since this allows a reduction in the expected computational cost compared with the original cascade.

It will be appreciated that the cascades D and E in the 2-object decision tree of FIG. 4 are interleaved, but the cascades in the 2-object decision tree of FIG. 5 are not interleaved. The interleaving of classifiers in FIG. 4 allows prior information to be built up from any object detector and used to optimise the chance of rejecting a patch as a candidate object. In particular, the interleaving of classifiers allows the results from every classifier to be used to introduce a re-ordered version of other classifiers.

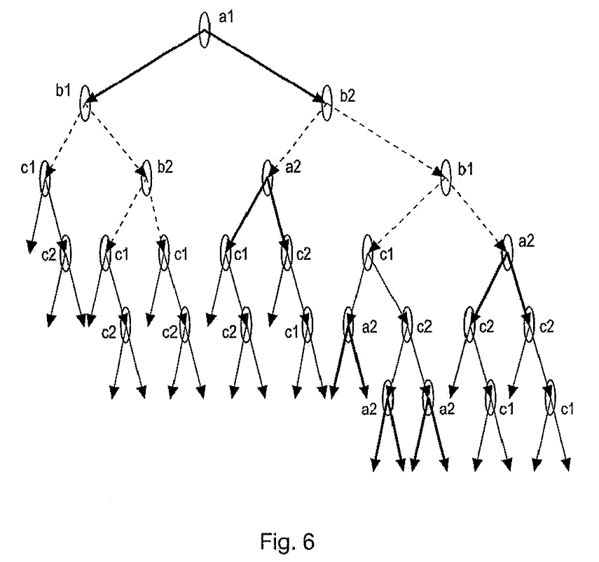

Considering now the embodiment illustrated in FIG. 6, this shows a 3-object decision tree which comprises an interleaving of the cascades of three object detectors A, B, C, each cascade comprising two classifiers a1, a2; b1, b2 and c1, c2. The detectors are configured to analyse the same patch of an image as the image is analysed patch by patch over all scales and orientations searching for objects. Each cascade has been trained as statistically characterised on the space of patches to be analysed by the detector and arranged in a computationally optimum order. The detectors are all rare-event detectors and possess a similar ability to quickly reject non-objects, which creates interdependencies between the results of the classifiers in each detector cascade. The statistical information about these interdependencies is collected using the restriction operation and used in an initial search stage to determine the preferred interleaving format of the cascades in the decision tree so as to reduce the expected computational cost in searching an image for all three objects compared with the computational cost of running the three object detectors A, B, C, independently.

The initial search stage involves calculating the computational cost of multiple possible decision trees within the space of logically equivalent decision trees so that one with a minimum expected computational cost can be selected. The expected computational cost is the cost of evaluating the image feature test associated with a classifier multiplied by the probability of such a classifier being evaluated. The probability of a classifier being evaluated is dependent on the particular decision tree and upon the conditional probability of a particular test accepting a patch given the results of evaluating earlier image feature tests of classifiers from any cascade. Large numbers of such conditional probabilities need to be calculated. However, many of the decision trees in the field will have similar expected computational costs based on the fact that the interleaving of cascades in these trees does not make use of any interdependencies. This property is used to reduce the calculations involved in the initial search stage by grouping as a single class those decision trees that do not make use of any dependencies.

In FIG. 6 the evaluation of all the cascades A, B, C are both interleaved and inter-dependent.

An evaluation of the image feature test of a classifier a1 yielding an “accept” decision is followed by the evaluation of the image feature test of classifier b2, and so the evaluation of cascade A overlaps or is interleaved with cascade B. If classifiers a1 and b2 are accepted and b1 is rejected then a2 is not evaluated until both classifiers c1 and c2 are evaluated, so the evaluation of cascade A overlaps or is interleaved with the evaluation of both cascade B and C. On other routes through the 3-object decision tree, the different versions or arrangements of cascade C are evaluated after the other cascades A and B have reached their object detection decision.

The evaluation of cascade A is independent of the other cascades. The evaluation of cascade B is dependent on the result of classifier a1 and hence is dependent on cascade A. The evaluation of cascade C is dependent on both the other cascades A and B. Nothing is dependent from cascade C.

Since the cascades each have only two classifiers, and classifier a1 is evaluated first, then it can only be followed by classifier a2 and so only one version or rearrangement of cascade A is used. Alternatively, restricting the 3-object decision tree to classifiers from object detector A only, yields a single version of cascade A. Thus the expected cost of evaluating cascade A is constant and its position in the 3-object decision structure is due to its classifiers providing useful information to guide the use of versions of the other cascades. Therefore if there is any speedup, it must come from the expected reduced cost of evaluating the other cascades B and C.

The evaluation of cascade B is dependent on the classifier a1. If the classifier a1 reaches a “reject” decision then classifier b1 is evaluated next; whereas if classifier a1 reaches an “accept” decision then classifier b2 is evaluated next. Using the restriction operation for detector B, firstly, the classifiers from cascade C are hidden to obtain a singleton set of N-object decision trees. Secondly, the classifier a2 is hidden, and since the classifier a2 only occurs as a leaf, this again yields a singleton set. Finally, it is only when the classifier a1 is hidden that two decision trees result showing the dependence on the classifier a1. More broadly, when the 3-object decision structure in FIG. 6 is restricted to classifiers from cascade B, then two versions or arrangements of cascade B are revealed which indicates that the evaluation of cascade B is dependent on the other decision sub-structures in the form of cascade A.

The evaluation of cascade C is dependent on the evaluations of both cascades A and B in the 3-object decision tree of FIG. 6. If we simply restrict the 3-object decision tree to the classifiers of cascade C there will be the two possible arrangements or versions of cascade C. This indicates that the evaluation of cascade C in the 3-object decision tree is dependent on the other evaluation of the other cascades A and B. The detailed dependency in terms of particular classifiers is more complex. In particular, if classifier a1 is rejected then c1,c2 is preferred; if classifiers a1, b2, and b1 are accepted then c2,c1 is preferred; if classifiers a1,a2 are accepted and b2 is rejected then <c1,c2> is preferred.

A more complex example with more than two classifiers in a cascade would be required to show an example of the evaluation of three decision sub-structures that are each dependent on the evaluation of both the other decision sub-structures. i.e. full inter-dependency of all three detectors.

In the embodiment of FIG. 6, the object detectors A, B, C each comprise a cascade of classifiers. However, in alternative embodiments of the invention, one or more of the object detectors may instead have a decision structure in the form of a decision tree. However, it will be appreciated that a decision tree can be re-arranged in a similar manner to a cascade whilst still preserving its logical performance.

Furthermore, the decision structure, whether cascade or decision tree, may use binning. However, binning restricts the possible re-arrangements of the decision structure that have the same logical performance, and some re-arrangements may be used which change the logical performance, but where this change can be tolerated.

In exceptional circumstances, the extra knowledge obtained from the overall set of classifiers evaluated makes a classifier in a cascade redundant. In some cases, this means the object detector immediately rejects the patch. In others, it means removing a classifier from the remaining cascade, for example, in a face detector where the first classifier in each cascade is always a variance test for the patch.

### Expected Computational Cost of a Single Object Detector

An expression for the expected computational cost of a cascade is described by way of introduction to an analysis of the expected computational cost of an N-object detector.

The cascade of a single object detector can be considered as a special case of a decision tree DT which can be defined recursively below:

DT=empty( )|makeDT(CLASSIFIER,DT,DT)

A decision tree is either empty (a leaf) at which point a decision has been reached or it is a node with a classifier and two child decision trees or sub-trees. A non-empty decision tree causes the classifier to be evaluated on the current patch followed by the evaluation of one of the sub-trees depending on whether the patch is accepted or rejected by the classifier. The first sub-tree is evaluated when the classifier “accepts” a patch, and the second sub-tree is evaluated when the classifier “rejects” a patch.

It is worth noting that a cascade is a structure where the reject sub-tree is always the empty constructor. i.e. it is a leaf and not a sub-tree.

The cost of computing a single weak classifier from the cascade of weak classifiers is given as Cᵢ^{s} for the i^{th} element of the sequence of weak classifiers (s). For a Viola-Jones object detector this does not vary with the region or patch, but it would be relatively simple to adapt this cost measure for cases where the computational cost of evaluating an image feature test of a classifier varied with the particular patch of the image being tested.

An expression for the cost of classifier computation on a single patch (r) is the sum of the costs of each stage of the cascade that is evaluated. Evaluation terminates when a classifier rejects a patch. In a mathematical notion cost is defined as:

cost(s,r)=cost(s,0,r)

where the cost is defined recursively

cost (s,n,r) =
if(n>=lengths (s)) then 0
else if (rejects(s, n, r)) then Cₙ^{s}
else Cₙ^{s} = cost(s, n + 1, r)

where s is a sequence of classifiers forming the cascade; n is a parameter indicating the current classifier being considered or evaluated; the function length returns the length of a sequence.

A simple expression for the expected cost is obtained by summing the product of the cost of evaluating each classifier in the cascade and multiplying by the probability that this classifier will be evaluated.

The expected cost in terms of the cost of evaluating a weak classifier Cᵢ^{s} and the probability of the classifier being evaluated (P) comprises:

$$Exp [ cost ( s , r ] = {C}_{0}^{s} + {\sum }_{i = 1 … length ( s ) - 1} {C}_{i}^{s} P ( s , i , r )$$

The probability of a particular classifier being evaluated is dependent upon the particular cascade. The probability of a classifier being evaluated is a product of conditional probabilities (Q) of a patch being accepted given the results of the previously evaluated classifiers in the cascade:

$$P ( s , n , r ) = {\prod }_{i = 0 … n - 1} Q ( s , i , r )$$

$$\begin{matrix}Q ( s , 0 , r ) = Pr [ accepts ( s , 0 , r ) ] \\ Q ( s , 1 , r ) = Pr [ accepts ( s , 1 , r ) \vert accept ( s , 0 , r ) ] \\ Q ( s , 2 , r ) = Pr [ accepts ( s , 2 , r ) \vert accept ( s , 0 , r ) \hat{} accept ( s , 1 , r ) ] \\ Q ( s , 3 , r ) = Pr [ accepts ( s , 3 , r ) \vert accept ( s , 0 , r ) \hat{} accept ( s , 1 , r ) \hat{} accept ( s , 2 , r ) ] \\ ⋯ \\ Q ( s , n , r ) = Pr [ accept ( s , n , r ) \vert {⋀}_{i = 0 … n - 1} accept ( s , i , r ) ]\end{matrix}$$

With the exception of the first predicate, Q is the conditional probability that a given patch is accepted by the nth classifier given that all previous classifiers accepted the patch.

Some observations follow from this expression:
1. It is better to choose an initial classifier in the cascade that has lower cost, but it is also important that a classifier rejects as many patches as soon as possible so that later stages are not evaluated.
2. Reordering the sequence of classifiers in the cascade will change the expected cost of the cascade.
3. The contribution to the overall cost made by the later stages of the cascade is insignificant. This is because the weight given to each cost is a product of probabilities, each of which is less than one and so later overall cost contributions converge to zero.
4. Making optimum choices for the initial classifiers of the cascade will achieve most of the benefits.
5. It is difficult to predict the probability of later stages accepting/rejecting a patch because the space of patches is greatly pruned by earlier classifiers. A simple model would replace the later probabilities with a uniform random choice (0.5).
6. The condition used as prior knowledge is the fact that the patch has been accepted by earlier parts of the cascade. The “accept” decision made by a weak classifier in the cascade is a binary decision taken using a threshold. Other approaches use a weight to indicate the importance of the classifier and some normalised scalar value that was used in the threshold. Similar prior knowledge could be exploited.
7. However, if we consider the evaluation of a single cascade in the context of a set of other object detectors then there is a richer set of prior knowledge that can be optimised. This extra knowledge would be results from the classifiers that had been evaluated by the other object detectors. This would give both a larger set of classifiers that had accepted the patch as well a set of classifiers that had rejected the patch.
8. The expression for the expected cost of the cascade can be adapted (by simple conjunction of the extra conditions) to give this extra prior knowledge from the other object detectors. This would give a means of adapting a cascade to particular prior knowledge from the other object detectors, but would not allow optimisation of the whole system of object detectors. For this it would be necessary to derive an N-object decision tree from the input cascades.

### Expected Computational Cost of an N-object Decision Tree

An expression for the expected computational of an N-object decision tree is now considered.

An N-object data tree is an example of an N-object decision structure that at run-time calculates the decision of N object detectors and determines the order in which image feature tests associated with a classifier from the different object detectors are evaluated.

An object detector incorporating cascades from multiple object detectors can be considered as an N-object decision tree NDT derived recursively as follows:

NDT=empty( )|makeNDT(OBJECT_ID×CLASSIFIER,NDT,NDT)

NDT is either empty or contains a classifier labelled with its object identifier, and two other N-object decision trees. The first N-object decision tree is evaluated when the classifier “accepts” a patch, and the second N-object decision tree is evaluated when the classifier “rejects” a patch.

When an N-object decision tree is derived from the cascades of the input object detectors it will possess a number of important properties making it different from an arbitrary decision tree as follows:
1. When the decision tree is restricted to a particular object detector the result is a set of cascades, and these will include re-orderings i.e. versions of the original input cascade for the object detector.
2. At every leaf of the decision tree—the results of all the object detectors will have been obtained, and these results will be the same as those obtained by running each object detector independently.
3. The only classifiers that are run are the classifiers from the input object detectors.

The cost of evaluating an N-object decision tree on a patch is simply the sum of the cost of evaluating each classifier that gets evaluated for the particular patch. The classifiers that get evaluated are decided by the results of classifier evaluated at each node.

In a mathematical notation, the cost of evaluating a particular patch and decision tree is defined recursively by:

```
cost(empty( ), patch) = 0
cost(makeNDT((id, classifier), accept, reject), patch =
ClassifierCost(classifier, patch) +
(if (accept(classifier, patch))
then
    cost(accept, patch)
else
    cost(reject, patch)
endif
)
```

The expected cost of evaluating an N-object decision tree is the sum of the cost of evaluating the classifier on each node of the tree multiplied by the probability of that classifier being evaluated.

The expected cost of evaluating an N-object decision tree on a patch can be derived as

Exp[cost(dt,patch)]=ExpCostNDT(dt,{ },{ })

where we define the expected cost recursively

```
ExpCostNDT(empty( ), as,rs) = 0
ExpCostNDT(makeNDT((id, classifier), accept, reject), as, rs) =
    ExpClassifersCost(classifier) +
    (let
        (p = Pr[accept(classifier, patch) | makeCondition(as, rs, patch)])
    in
        pExpCostNDT(accept,Append(as,(id, classifer),rs) +
        (1 − p)ExpCostNDT(reject, as, Append(rs, (id, classifier)))
```

Where as, rs are accumulating parameters indicating the previous classifiers that had been accepted or rejected respectively. Append is a function adding an element to the end of a sequence.

The condition for the probability of accepting a patch is formed from the conjunction of the classifiers that “accept” and “reject” the patch

makeConditions(as,rs,patch)=AcceptConditions(as,patch)̂RejectCondition(rs,patch)

where the accept condition is the conjunction over the list of the conditions that each classifier in the list is accepted

AcceptCondition({ },patch)=true

AcceptCondition(Append(as,(id,classifier)),patch=accept(classifier,patch)̂AcceptCondition(as,patch)

and, where the reject condition is the conjunction over the list of the conditions that each classifier in the list is accepted

RejectCondition({ },patch)=true

RejectCondition(Append(rs,(id,classifier)),patch=reject(classifier,patch)̂RejectCondition(rs,patch)

### Interleaving of Decision Sub-Structures in an N-Object Decision Structure

Interleaving is most easily understood by considering the routes through an N-object decision tree.

A route through a decision structure is a sequence of classifiers (possibly tagged with the object identifier) that can be generated by evaluating the decision structure on some patch and recording the classifiers (and associated object identifier) that were evaluated.

The result of the classifier evaluation should also be recorded as part of the route, although with a cascade decision structure much of this information is implicit (every classifier in the sequence, but the last one, must have been accepted otherwise no further classifiers would have been evaluated. However when the more general decision tree is used as the decision structure, other classifiers can be evaluated after a negative decision. Furthermore if binning is used then the result from the classifier can take more values.

A route through an N-object decision structure is similar, but because such structures make N decisions there is also a need to record each of the N different decisions when they occur as well as the trace of the classifier evaluations.

Two decision sub-structures are interleaved in an N-object decision structure if there is at least one route through the decision structure where the sets of classifiers from the two object detectors are interleaved.

Two sets of classifiers are interleaved in a route if there exists a classifier from a first one of the sets for which there exists two classifiers from the second set, one of which occurs before and the other after the classifier from the first set.

Interleaving of decision sub-structures allows information about classifier evaluations to flow in both directions. This allows different versions of the sub-structures to be used to obtain speed-ups or rather expected computational cost reductions for both object detectors. Results from other object detectors are used to partition the space of patches and allows different versions of a sub-structure to be used for each partition.

Expected computational cost reductions are only obtained if different versions of the sub-structures are used to advantage (i.e. some re-arrangement of the decision structure that yields expected computational cost reductions for the different partitions of the space of patches).

The invention can also achieve improvements in expected computational cost even when the decision sub-structures are not interleaved, as shown in FIG. 5. In particular if one object detector is completely evaluated, then there will be a list of classifier results that can be used to partition the space of patches for the object detectors following and so optimum re-arrangements can be chosen for each partition and so reductions in expected computational cost can be obtained.

However, since the expect computational cost of each object detector is dominated by the cost of rejecting non-objects, it is best to communicate information from the less complex classifiers (or those less specific to the particular object detector). All the object detectors have a shared goal of rejecting non-objects. So the best performance is usually obtained by interleaving all the object detectors.

### Versions of Decision Sub-Structures

Different versions of a sub-structure in an N-object decision structure can be identified using the restriction operator. An N-object decision structure according to the invention will have at least one version of every input object detector.

If there is only one version for a sub-structure then the N-object decision structure cannot obtain an expected computational cost that is less than optimised arrangement of the object detector evaluated on its own.

So if each input object detector is optimised on its own before this method is applied then improved performance of a particular object detector can only be obtained if there are several versions of the corresponding sub-structure.

### Dependency of Decision Sub-Structures

An N-object decision structure independently evaluates its incorporated object detectors if every incorporated decision sub-structure only has one version. Versions of an incorporated decision sub-structure are identified by restricting the N-object decision structure to a particular object.

### Restricting an N-Object Decision Tree

This section discusses the definition of the restriction operator:

The restriction operator acts on an N-object decision structure to produce the set of different versions of the identified objects decision structures used as a decision sub-structure in the N-object decision structure,

When an N-object decision structure is restricted to a given object only two cases need to be considered:
1. When the node of the decision structure uses a classifier from this given object then this classifier will be used to build a set of decision structures with this classifier as a root node and with child nodes obtained by restricting each of the child N-object decision structures to the same object.
2. When the node of the decision structure does not use a classifier from the given object then this classifier is ignored and returns the union of the sets of decision structures obtained by restricting each of the child decision structures to the same object.

The restriction operator takes an object identifier and an N-object decision tree and returns a set of decision trees. Basically, if the classifier of the node is from the required object detector, the classifier is used to build decision trees by combining the classifier with the set of decision trees returned from applying the restriction operation to the accept and reject branches of the node; otherwise if the classifier is not from the required object detector, it returns the set of decision trees returned from applying the restriction operator to the nodes child decision trees.

The restriction operator that takes an object identifier and an N-object decision tree and produces a set of decision trees (DT_SET) can be defined as:

restriction(obj_id,makeNDT(oid,c,accept,reject) =
if(obj_id = oid)
then
makeDT_SET(c,restriction(obj_id,accept),restriction(obj_id,reject))
else
restriction(obj_id,accept)∪restriction(obj_id,reject))
endif

Where makeDT_SET is used to build a decision tree using the given particular classifier and any of the set of child decision trees given to use for the accept and reject branches of the decision tree:

makeDT_SET(c,accepts,rejects)={makeDT(c,a,r)|a: accepts,r: rejects}

The restriction operator provides:
1. A means of identifying the different versions or arrangements of the cascades from the original object detectors.
2. A means of determining whether the evaluation of a particular object detector is dependent on other decision sub-structures (or the evaluation of the other object detectors in the N-object decision tree). i.e. the evaluation of a particular object is independent of the others if the restrict operator returns a set with only one member (a singleton set).
3. A means of asserting that the decision trees obtained from the N-object decision tree by using the restriction operator have the same logical behaviour as the original object detector
   ∀p: PATCHES, oid: OBJECT_ID.
   (∀x: restriction(oid,ndt).eval(x,p)=eval(detector(oid),p))
A function eval is used to evaluate the cascade of an object detector on an image patch. The function detector is used to lookup the input detector associated with a given object identifier.
The decision obtained from the N-object decision tree is the same decision as generating the results from each of the input object detectors

### Generating N-Object Decision Structures

The invention provides a method of determining an N-object decision structure for an N-object detector that has optimal expected computational cost or has less expected computational cost than evaluating each of the object detectors independently.

The method involves generating N-object decision structures as candidate structures. Firstly it is useful to describe how to enumerate the whole space of possible N-object decision trees that can be built using the set of classifiers from the input object detectors.

Enumerating the Space of N-Object Decision Trees Firstly a set of events is derived by tagging each classifier occurring in one of the decision structures of the input object detectors with an object identifier.

Now, given this set of events it is possible to compose the space of N-object decision trees that can be constructed from this set of events.

A recursive definition of a procedure for enumerating the set of N-object decision trees from a set of events comprises:
1. Each event in the set of events (the object id tagged classifiers) is used to generate an N-object decision tree that uses this event as the parent node.
2. This node is constructed by combining this event with every N-object decision tree that can be used for either the accept branch or reject branch of the tree.
3. Proceeding recursively it is possible to generate the set of events that can occur after a particular event has been accepted and to make a recursive call of the means of enumeration defined to generate the set of N-object decision trees that can be generated from the events possible after this accept decision. The set of events that can occur after an event has been accepted is simply the original set of events minus the event itself.
4. Similarly it is possible to generate the set of events that can occur after an event has been rejected and to make another recursive call of the means of enumeration defined to generate the set of N-object decision generated from the events possible after this rejection decision. The set of events that can occur after an event has been rejected is simply the original set minus every event that was tagged with the same object identifier. Once one event tagged with a particular object identifier is rejected then there are no other events from that object.

This recursive enumeration ensures that:
1. Every event occurs only once (at most) in any route through the decision tree.
2. An object is only accepted if all the classifiers from that object have been accepted.
3. Once an object is rejected then no further events tagged with the same object identifier occur.
4. The classifiers from the different object detectors can be interleaved, in the sense that it is possible for a classifier of one object detector to occur both before and after classifiers from another object detector.
5. The order that classifiers occur in the N-object decision trees is not constrained by the original order in which the classifiers occurred in the input cascades.

In a mathematical notation, a function is defined to generate the set of possible N-object decision trees

NDTenumerate[Events]={makeNDT(e,a,r)|eεEventŝaεNDTaccepts[e,Events]̂rεNDTrejects[e,Events]}

### Where

NDaccepts[e,Events]=NDTenumerate[Events−{e}]
i.e. an enumeration of the possible NDTs with a set of events minus the node event

NDrejects[e,Events]=NDTenumerate[Events−{x|sameobjectid[x,e]}]

Where sameobjectid is a predicate checking whether the two events are tagged with the same object identifier

This method can be easily adapted to enumerate the space of other possible N-object decision structures.

### Randomly Generating N-Object Decision Trees

The procedure for enumerating every possible N-object decision tree can be easily adapted to randomly generate N-object decision trees from a set of classifiers. This avoids the need to enumerate the entire space of N-object decision trees.

A recursive random procedure for generating an N-object decision tree comprises:
1. Given a set of events one is chosen randomly.
2. Recursive calls are made to generate an N-object decision tree for the accept and reject branches of the N-object decision tree node.
3. The N-object decision tree randomly generated for the accept branch uses the original set of events minus the event chosen randomly.
4. The N-object decision tree randomly generated for the reject branch uses the original set of events minus all events sharing the same object identifier as a tag.
5. The N-object decision tree return is composed using the randomly selected event and the randomly generated accept and reject branches.

The random choice of events can be biased so that some classifiers are more likely to be selected than others. For example, if the original cascade of an object detector is optimised or arrange in complexity order of the image feature test applied by a classifier on a patch, then biasing the choice to prefer the earlier members of the cascade or less the one that have least complexity or are least specialised to the particular object detector.

### Evolutionary Techniques for Finding a Satisfactory N-Object Decision Tree

Unlike randomly generated N-object trees, evolutionary generated N-object trees do not take advantage of the finding of a reasonable N-object decision tree to guide the search for an even better one. Evolutionary programming techniques such as genetic algorithms provide a means of exploiting the finding of good candidates.

The algorithms work by creating an initial population of N-object decision trees, allowing them to reproduce to create a new population, performing a cull to select the “best” members of the population, and allowing mutations to introduce random elements into the population. This procedure is iterated for a number of generations and evolution is allowed to run its course to generate a population from which the best in some sense e.g. computational cost is selected as the one found by the search procedure.

A genetic algorithm is an example of such programming techniques. It usually consists of the following stages:
1. An initial population of guesses of the solutions to the problem (perhaps a randomly generated one)
2. A way of calculating how good or bad the individual solutions are within the population.
3. A method for mixing fragments of the better solutions to form new on average better solutions.
4. A mutation operator to avoid permanent loss of diversity with the solutions.
   A genetic algorithm may be devised for finding a satisfactory N-object decision tree in which the initial population of N-object decision trees uses a particular set of classifiers provided by the input object detectors to randomly generate a population, and each N-object decision tree is compared according to its expected computational cost. New candidate N-object decision trees are generated iteratively by re-arranging and/or combining N-object decision structures of the initial population.

### Aggregation

The cost of performing the search to find a suitable N-object decision structure for integrating the N-object detector is affected by the number of classifiers in the original object detectors. There is a combinatorial increase in search cost as the number of classifiers increases. However there is a solution that reduces this cost. Several classifiers in an input cascade can be combined or aggregated into a single virtual cascade as far as the search is concerned. This reduces the computational cost of the following search.

Aggregation transforms the set of input decision structures into another set of decision structures. Aggregation is applied to one or more input cascades and performs the following steps:
Two or more adjacent classifiers are combined and replaced by a single virtual classifier that has the same logical behaviour as the cascade of adjacent classifiers that it replaces. This transformation preserves the logical behaviour of the input cascade.
Preliminary reordering of the input cascade can be performed before adjacent classifiers are combined. This allows a single virtual cascade to replace arbitrary subsequences of the input cascade.
The aggregation step can be repeated on the resulting cascade with the virtual cascade.

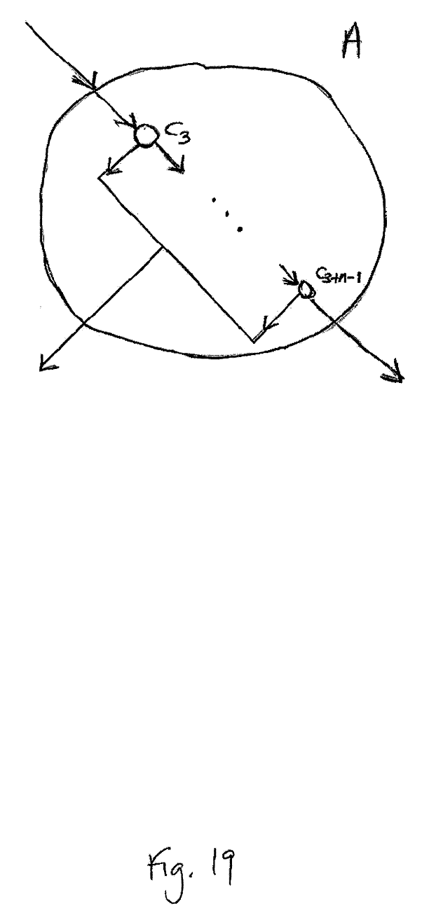

FIG. 18 shows such an aggregation step being applied to an input cascade. The aggregation transformation replaces the sequence of n classifiers c3, . . . c3+n−1 with a single virtual classifier A.

FIG. 19 shows the logical behaviour of virtual classifier A. The negative results from each of the classifiers c3, . . . c3+n−1 are combined into a single negative result whereas the previous positive result from the cascade is preserved.

There is less fine information about the reason for rejecting a particular patch. This can reduce the distinctions that can be made available to the other object detectors during the search for a suitable N-object decision structure for integrating the input object detectors but can reduce the search cost as the number of classifiers increases. A reduced integration time search is traded against potentially reduced run-time performances.

### Transformation Rules for Equivalent Decision Trees

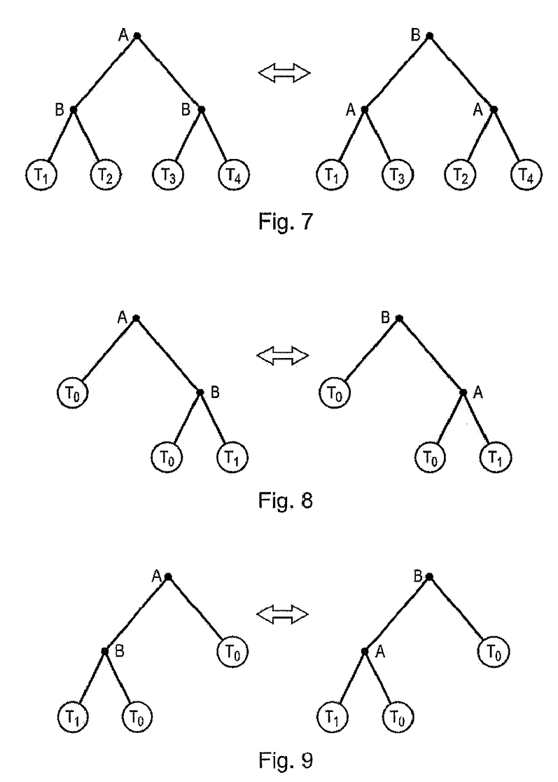

FIGS. 7 to 11 illustrate a set of five transformation rules for transforming one decision tree into another decision tree with the same logical behaviour. The closure of these transformation rules defines an equivalence class of decision trees that have the same logical behaviour. Many of these decision trees will have different expected computational cost for evaluation. These transformation rules can be used to generate new candidate N-object decision trees as one of the steps of the method according to the invention.

Rule 1: Duplicated classifiers. This rule illustrated in FIG. 7 exploits the occurrence of duplicated classifiers in each branch of the decision tree to swap the order of the classifiers.

Rule 2: Independent Reject is illustrated in FIG. 8, and Rule 3: Independent Accept is illustrated in FIG. 9. These two rules exploit the occurrence of sub-trees that are independent of the ordering of a pair of classifiers.

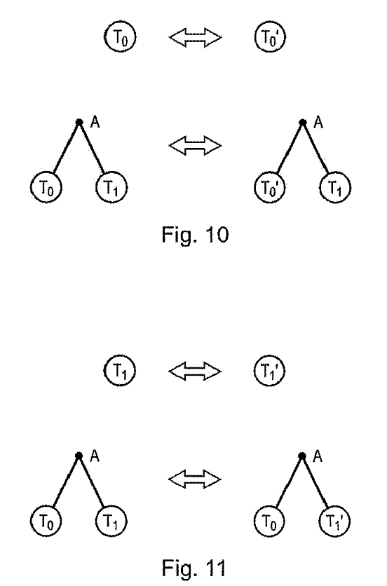

Rule 4: Substitution for a Reject Branch is illustrated in FIG. 10, and Rule 5: Substitution for an Accept Branch is illustrated in FIG. 11.

These transformation rules are now used by way of example to demonstrate that the decision tree of FIG. 1 is equivalent to the decision tree of FIG. 5 and FIG. 2.

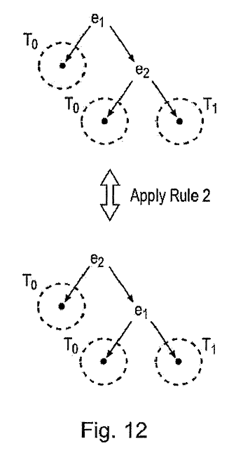

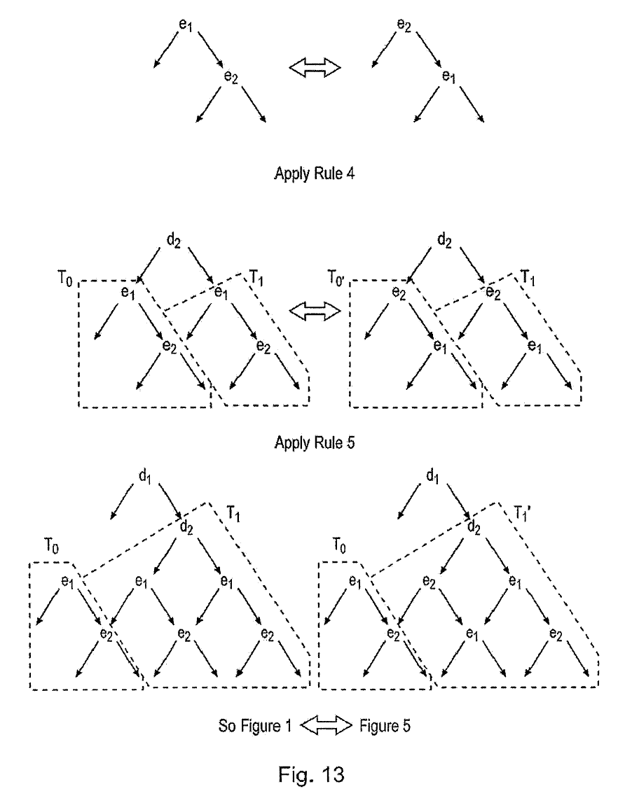

Starting with the cascade e1, e2, FIG. 12 illustrates the application of Rule 2 for Independent Reject to swap the order of the classifiers in the cascade to e2, e1 and thereby generate an equivalent decision tree, where A matches e1 and B matches e2 and T₀ matches all the reject decisions and T₁ matches the accept decision.

The equivalent decision trees from FIG. 12 are then processed further using the Substitution Rules in FIG. 13. Firstly, Rule 4: the Substitution Rule for a Reject Branch is applied, where A matches the classifier d2, T₀ and T₁ match the decision tree e1, e2, and T₀′ matches the decision tree e2, e1. This generates two new equivalent decision trees. Secondly, Rule 5: the substitution Rule for an Accept Branch is then applied to the two new decision trees, where A matches the classifier d1, and T₁ and T₁′ match the two new decision trees. The resulting equivalent decision trees shown at the bottom of FIG. 13 can be seen to be identical to the decision trees of FIGS. 1 and 5, respectively.

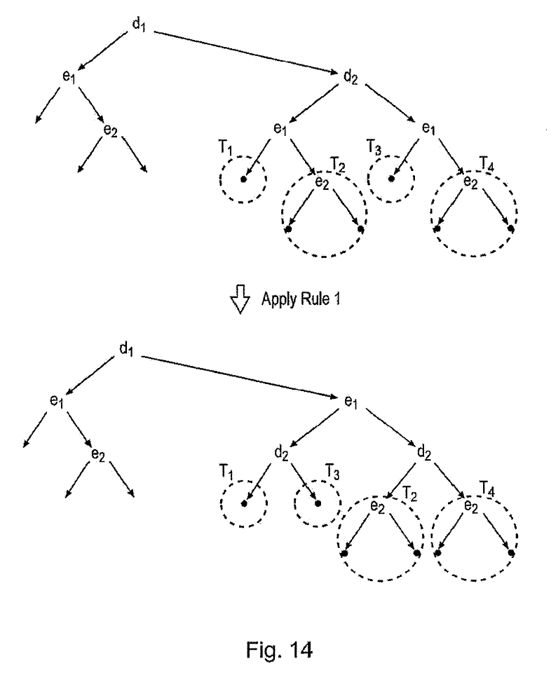

The decision tree shown in FIG. 1 can be transformed into the equivalent decision tree of FIG. 2 in four steps using Rule 1: Duplicated Classifiers, in each step as shown in FIGS. 14 to 17.

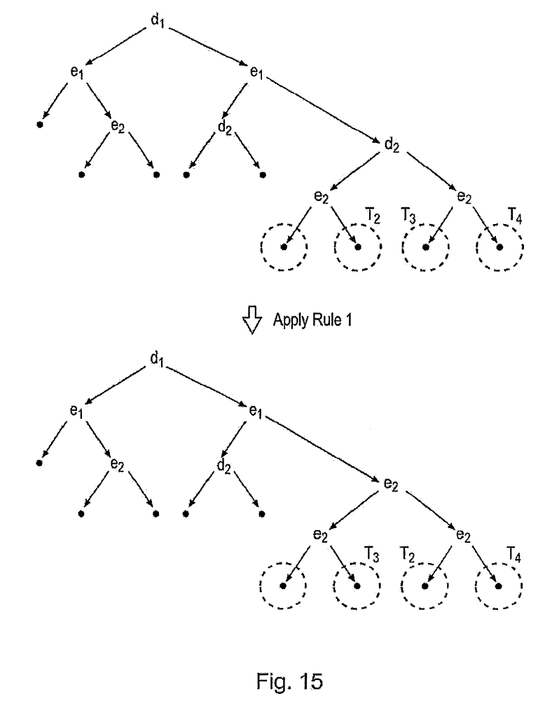

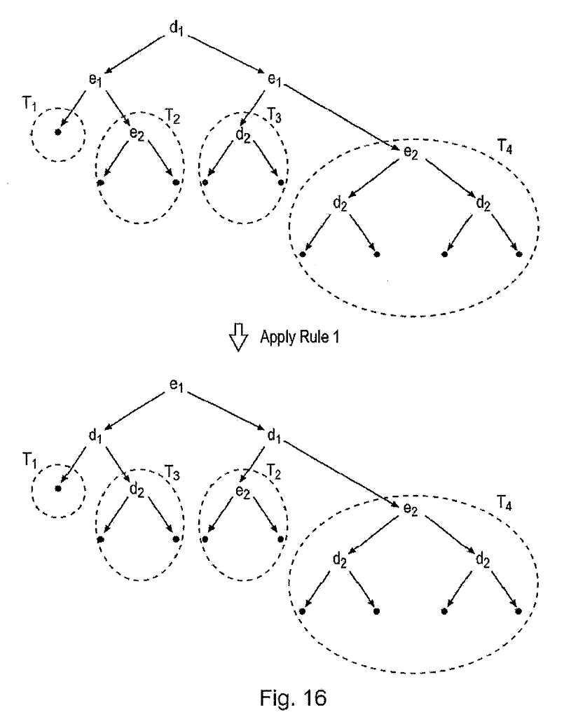

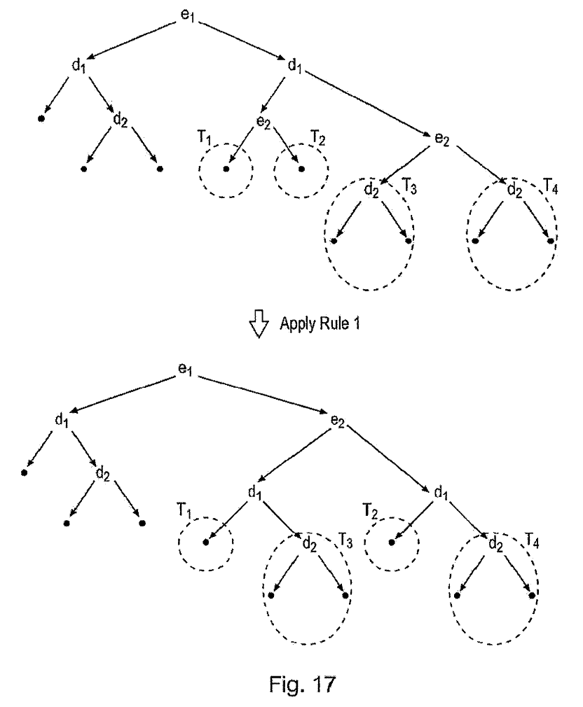

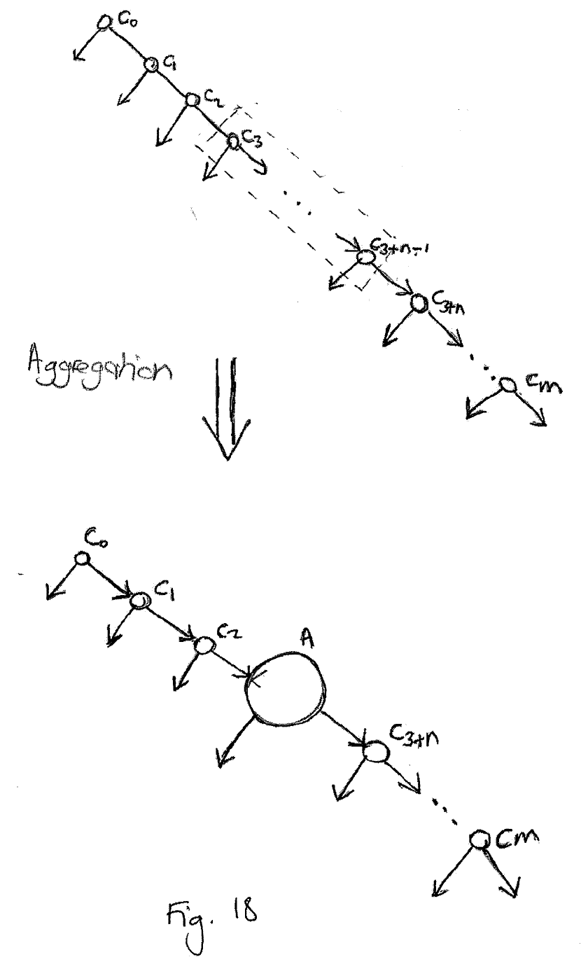

In FIG. 14 starting with the decision tree of FIG. 1, Rule 1 is applied to interchange the order of the classifiers d2, e1 in the accept branch after classifier d1, where A matches d2, B matches e1, and T₁ and T₃ match empty, and T₂ and T₄ match e2. Next in FIG. 15, the resulting equivalent decision tree is processed using Rule 1 to interchange the order of the classifiers d2 and e2 in the accept branch d1, e1, d2, e2, where A matches e2, B matches d2, and T₁, T₂, T₃ and T₄ all match empty. Next in FIG. 16, the resulting equivalent decision tree from FIG. 15 is processed using Rule 1 to interchange the order of the classifiers d1 and e1 in the accept branch d1, e1, e2, where A matches d1, B matches e1, and T₁ matches empty, T₂ matches e2, T₃ matches d2 and T₄ matches e2, d2. Finally, in FIG. 17, the resulting equivalent decision tree from FIG. 16 is processed using Rule 1 to interchange the order of the classifiers d1 and e2 in the accept branch e1, d1, e2, d2, where A matches d1, B matches e2, and T₁ and T₂ match empty and T₃ and T₄ match d2. Now comparing the decision tree at the bottom of FIG. 17 with that of FIG. 2, it can be seen that they are identical.

### Some Properties of the N-Object Decision Tree Generated

Some properties of an N-object decision tree generated according to the invention using N-object detectors comprises:
1. Only the same classifiers are evaluated.
2. The N-object decision tree restricted to one of the object identifier is a subset of the possible re-orderings of that decision tree
3. It has the same logical behaviour as evaluating each of the object detectors independently (in sequence for example).

4. Improved performance

1. An N-object detector comprising an N-object decision structure incorporating multiple versions of each of two or more decision sub-structures interleaved in the N-object decision structure and derived from N object detectors each comprising a corresponding set of classifiers, some decision sub-structures comprising multiple versions of a decision sub-structure with different arrangements of the classifiers of one object detector, and these multiple versions being arranged in the N-object decision structure so that the one used in operation is dependent upon the decision sub-structure of another object detector, wherein at least one route through the N-object decision structure includes classifiers of two different object detectors and one of the two object detectors occurs both before and after a classifier of the other of the two object detectors and there exists multiple versions of each of two or more of the decision sub-structures of the object detectors, whereby the expected computational cost of the N-object decision structure in detecting the N objects is reduced compared with the expected computational cost of the N object detectors operating independently to detect the N objects.

2. An N-object detector as claimed claim 1 in which each of the versions of a decision sub-structure produce the same logical behaviour.

3. An N-object detector as claimed in claim 1 in which each of the versions of a decision sub-structure have a minimum defined logical behaviour that is preserved in operation.

4. An N-object detector as claimed in claim 3 in which the minimum logical behaviour of each version of a decision sub-structure is dependent on the logical behaviour of one or more decisions about the detection of other objects.

5. An N-object detector as claimed in claim 4 in which the minimum logical behaviour asserts that only one object detector from a subset of the N object detectors can reach a positive decision and said positive decision is only reached if said one object detector would have reached a positive decision if evaluated independently.

6. An N-object detector as claimed in claim 4 in which the minimum logical behaviour asserts that one object detector can reach a positive decision on the basis of a logical combination of the decisions from one or more other detectors.

7. An N-object detector as claimed in claim 1 in which the N-object detector has the same logical behaviour as all of the N-object detectors operating independently.

8. An N-object detector as claimed in claim 1 in which the set of classifiers of each object detector comprises a decision tree of classifiers.

9. An N-object detector as claimed in claim 1 in which the set of classifiers of each object detector comprises a cascade of classifiers.

10. An N-object detector as claimed in claim 1 in which the decision sub-structures are such that they use binning.

11. An N-object detector as claimed in claim 10 in which the binning involves a classifier returning a real value indicative of the certainty with which the classifier has accepted or rejected a proposition posed by the classifier.

12. An N-object detector as claimed in claim 11 in which the value returned by the classifier is passed onto and used by other classifiers in the decision sub-structure.

13. An N-object detector as claimed claim 1 in which the N-object decision structure uses binning.

14. An N-object detector as claimed claim 1 in which the N-object decision structure comprises an N-object decision tree.

15. A method for generating an N-object decision structure for an N-object detector comprising:
a. providing N object detectors each comprising a set of classifiers,
b. generating multiple N-object decision structures each incorporating two or more interleaved decision sub-structures derived from the N object detectors, some decision sub-structures comprising multiple versions of a decision sub-structure with different arrangements of the classifiers of an object detector, the multiple versions being arranged in at least some N-object decision structures so that at least one version of a decision sub-structure of an object detector is dependent upon the decision sub-structure of another object detector,
c. analyzing the expected computational cost of the N-object decision structures in detecting all N objects and selecting for use in the N-object detector an N-object decision structure according to its expected computational cost compared with the expected computational cost of the N object detectors operating independently.

16. A method as claimed in claim 15 in which the selected N-object decision structure is the one with the least expected computational cost.

17. A method as claimed in claim 15 in which each of the versions of a decision sub-structure are generated to produce the same logical behaviour.

18. A method as claimed in claim 15 in which each of the versions of a decision sub-structure are generated to have a minimum defined logical behaviour that is preserved in operation.

19. A method as claimed in claim 15 in which each of the N-object decision structures are generated to have the same logical behaviour as all of the N object detectors operating independently.

20. An object detector for determining the presence of a plurality of objects in an image, the detector comprising a plurality of object decision structures incorporating multiple versions of each of two or more decision sub-structures interleaved within the object decision structures and derived from a plurality of object detectors each comprising a corresponding set of classifiers, wherein a portion of the decision sub-structures comprise multiple versions of a decision sub-structure with different arrangements of the classifiers of one object detector, wherein the multiple versions are arranged in the decision structure such that the one used in operation is dependent upon the decision sub-structure of another object detector.
